(19) United States
(12) Patent Application Publication
(10) Pub. No.: US 2017/0316685 A1
(43) Pub. Date: Nov. 2, 2017

(54) VEHICLE ACCIDENT MANAGEMENT SYSTEM AND METHOD FOR OPERATING SAME

(71) Applicant: SUK JU YUN, Cheonan-si (KR)

(72) Inventor: SUK JU YUN, Cheonan-si (KR)

(21) Appl. No.: 15/499,828

(22) Filed: Apr. 27, 2017

(30) Foreign Application Priority Data
Apr. 28, 2016 (KR) 10-2016-0052078

(51) Int. Cl. G08G 1/01; G08G 1/0965; G08G 1/16; G08G 1/0967; G01S 19/13

(52) U.S. Cl. CPC G08G 1/0112; G08G 1/164; G08G 1/096775; G08G 1/0965; G01S 19/13

(57) ABSTRACT

Disclosed herein are a vehicle accident management system and a method for operating the same. The method for operating a vehicle accident management system including vehicles configured such that respective vehicle terminal devices are attached thereto and an accident management device installed on a roadside includes: transmitting, by a first vehicle terminal device, accident and location information to the accident management device when a vehicle abnormality detection signal or a risk signal attributable to user operation is generated; receiving, by the accident management device, the information; searching, by the accident management device, for a second vehicle terminal device having a moving direction identical to that of the first vehicle terminal device and located within a preset distance behind the first vehicle terminal device; and transmitting, by the accident management device, the information to the second vehicle terminal device based on the result of the search.

### BACKGROUND

### 1. Technical Field

The present invention relates to a vehicle accident management system and a method for operating the same. More specifically, the present invention relates to a vehicle accident management system including vehicles configured such that respective vehicle terminal devices are attached thereto and an accident management device installed on a roadside, and also relates to a method for operating the vehicle accident management system.

### 2. Description of the Related Art

A conventional anti-lock braking system installed in a vehicle, a conventional electronic driving safety device installed in a vehicle, or a conventional voice recognition function configured to prevent a driver from becoming drowsy or negligent while driving is provided only to a vehicle or user that employs a specific service or platform, thereby being unable to provide information reflecting an actual situation.

Accordingly, there is a need for a technology capable of enabling a vehicle to continuously communicate with a road infrastructure and other vehicles while traveling and to share various types of information, such as a traffic situation and the like, with other vehicles. In response to this need, vehicle to everything (V2X) technology including vehicle to vehicle (V2V) technology and vehicle to infrastructure (V2I) technology configured to fundamentally prevent an accident or minimize casualties upon occurrence of an accident has appeared.

In Korea, traffic accidents attributable to fog or sea fog generated on a bridge or a road close to the sea occur frequently due to geographical characteristics, and the accidents often lead to serial rear-end collision accidents, thereby causing considerable social loss. The V2X technology enables a vehicle to communicate with a road infrastructure and another vehicle while traveling and to share a traffic situation with another vehicle, thereby effectively preventing serial accidents because the V2X technology enables the approach of a vehicle, forward traffic information, and the like to be shared in real time.

Accordingly, there is a need for the development of a vehicle accident management system that can notify vehicles entering a driving environment of a sudden change in the driving environment attributable to fog, sea fog, a forward traffic accident, or the like via the V2X technology, thereby inducing a driver to drive safely and preventing a secondary accident from occurring.

### SUMMARY

The present invention is conceived to solve the above-described problems, and an object of the present invention is to provide a vehicle accident management system that can notify neighboring vehicles of a sudden change in a forward driving environment, and thus a vehicle entering the corresponding driving environment is enabled to detect a dangerous situation, thereby preventing a secondary accident.

Furthermore, another object of the present invention is to provide a vehicle accident management system that enables information about an accident occurring within a predetermined range to be shared with neighboring vehicles in real time and also enables information, which a driver needs to be aware of, to be provided at required time, thereby making a traffic flow smooth.

Furthermore, still another object of the present invention is to provide a vehicle accident management system that enables only the following vehicles traveling in a direction identical to that of a vehicle involved in an accident to receive a risk detection signal without the transmission of the risk detection signal to preceding vehicles irrelevant to the accident, thereby enabling only the appropriate drivers to accurately become aware of the risk detection signal and to use the risk detection signal for safe driving.

The objects of the present invention are not limited to the above-described objects. Other objects and advantages of the present invention, which are not described above, will be apparent from the following description, and will be more clearly understood from the embodiments of the present invention. Furthermore, it will be easily appreciated that the objects and advantages of the present invention can be achieved using components set forth in the claims and the combinations thereof.

According to an aspect of the present invention, there is provided a method for operating a vehicle accident management system including vehicles configured such that respective vehicle terminal devices are attached thereto and an accident management device installed on a roadside, the method including: transmitting, by a first vehicle terminal device, accident information and location information to the accident management device when a vehicle abnormality detection signal or a risk signal attributable to user operation is generated; receiving, by the accident management device, the accident information and the location information from the first vehicle terminal device; searching, by the accident management device, for a second vehicle terminal device having a moving direction identical to that of the first vehicle terminal device and located within a preset distance behind the first vehicle terminal device; and transmitting, by the accident management device, the accident information and the location information to the second vehicle terminal device based on the result of the search.

According to another aspect of the present invention, there is provided a vehicle accident management system, including: a first vehicle terminal device configured to transmit accident information and location information to the accident management device when a vehicle abnormality detection signal or a risk signal attributable to user operation is generated; and an accident management device attached to a vehicle, and configured to receive the accident information and the location information from the first vehicle terminal device, to search for a second vehicle terminal device attached to another vehicle, having a moving direction identical to that of the first vehicle terminal device, and located within a preset distance behind the first vehicle terminal device, and to transmit the accident information and the location information to the second vehicle terminal device based on the result of the search.

### BRIEF DESCRIPTION OF THE DRAWINGS

The above and other objects, features, and advantages of the present invention will be more clearly appreciated from the following detailed description taken in conjunction with the accompanying drawings, in which:

FIG. 1 is a block diagram showing a vehicle accident management system according to an embodiment of the present invention;

FIG. 2 is a detailed block diagram showing an accident management device and a vehicle terminal device according to an embodiment of the present invention;

FIG. 3 is a diagram illustrating the exemplary operation of a vehicle accident management system according to an embodiment of the present invention; and

FIGS. 4 and 5 are flowcharts showing a method for operating a vehicle accident management system according to the present invention.

### DETAILED DESCRIPTION

The above-described objects, features, and advantages will be described in detail below with reference to the accompanying drawings. Accordingly, those having ordinary knowledge in the art to which the present invention pertains will easily practice the technical spirit of the present invention. In the description of the present invention, in the case in which it is determined that a detailed description of a well-known technology associated with the present invention may unnecessarily make the gist of the present invention unclear, it will be omitted. Preferred embodiments of the present invention will be described in detail below with reference to the accompanying drawings. Throughout the drawings, the same reference symbols designate the same components or similar components.

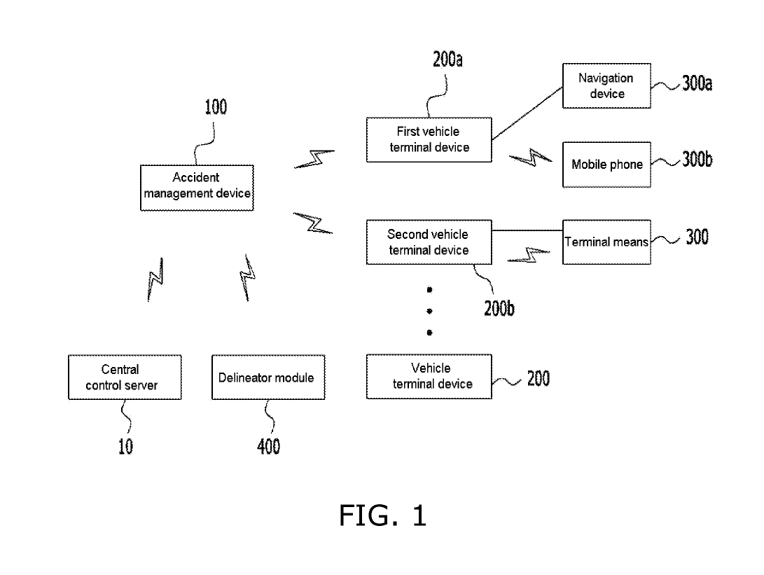

The configuration and exemplary operation of a vehicle accident management system according to embodiments of the present invention will be described below with reference to FIG. 1 to FIG. 3.

First, FIG. 1 is a diagram showing the configuration of a vehicle accident management system according to an embodiment of the present invention.

Referring to FIG. 1, the vehicle accident management system according to the embodiment of the present invention includes accident management devices 100 installed on roadsides, and vehicle terminal devices 200 attached to respective vehicles. The vehicle accident management system may further include a central control server 10, terminal means 300 configured to communicate with the vehicle terminal devices 200 via a wired or wireless connection, and delineator modules 400 installed on roadsides.

The accident management devices 100 may be installed on roadsides at predetermined intervals, may receive accident information and location information from a first vehicle terminal device, may search for a second vehicle terminal device having a moving direction identical to that of the first vehicle terminal device and located within a preset distance behind the first vehicle terminal device, and may transmit the accident information and the location information to the second vehicle terminal device based on the result of the search.

Furthermore, the accident management devices 100 may request the weather information of a region corresponding to the location information from the central control server, may receive the weather information from the central control server, and may transmit the weather information to the second vehicle terminal device.

Furthermore, the accident management devices 100 may search for a delineator module disposed in the moving direction of the first vehicle terminal device and located within a preset distance behind the first vehicle terminal device, and may transmit a lighting signal to the delineator module.

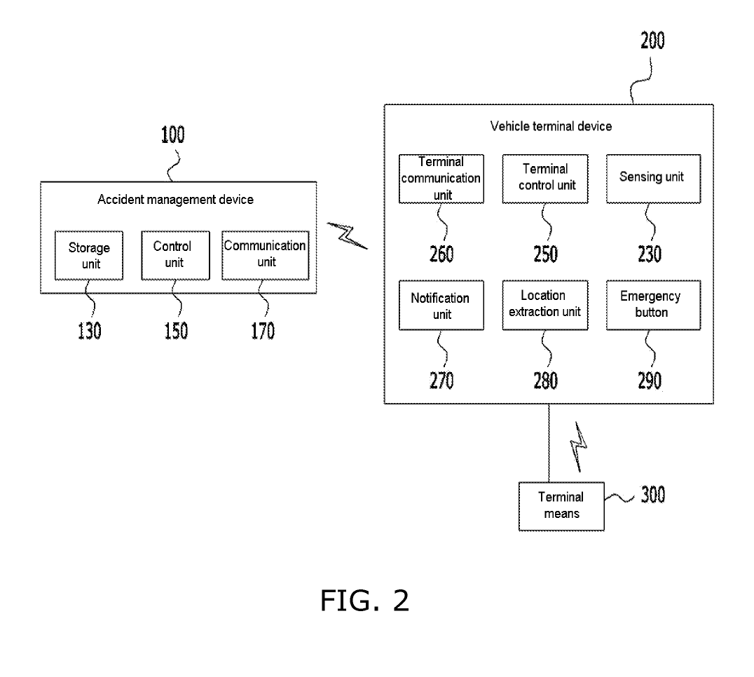

Each of the accident management devices 100 may include a storage unit 130, a control unit 150, and a communication unit 170, as shown in FIG. 2. More specifically, the storage unit 130 may include information about a neighboring delineator module, road information, identification information and location information regarding an adjacent one of the accident management devices 100 installed at predetermined intervals, current road state information received from the central control server 10, and information about a management region disposed within a road and managed by the corresponding accident management device 100. The storage unit 130 may regularly or irregularly update information, and may provide required information to the communication unit 170 under the control of the control unit 150.

The control unit 150 may control the operation of the corresponding accident management device 100, and may perform a required function by using received accident information and received location information. For example, when the accident information is received from the first vehicle terminal device, the control unit 150 may search for the second vehicle terminal device having a moving direction identical to that of the first vehicle terminal device and located within a preset distance behind the first vehicle terminal device. Furthermore, the control unit 150 may search for a delineator module disposed in the moving direction of the first vehicle terminal device and located within a preset distance behind the first vehicle terminal device. Moreover, the control unit 150 may include a GPS module, may extract information about the location of the corresponding accident management device 100, and may use the information about the location to set a management region disposed within a road and managed by the corresponding accident management device 100 and to also set the delineator modules 400.

The communication unit 170 communicates with the vehicle terminal devices 200, the delineator modules 400, and the central control server 10. In this case, the communication unit 170 may transmit and receive information via short-distance wireless communication, such as ZigBee communication, Bluetooth communication, RF communication, IrDa communication, Ultra-wideband communication, or WiFi communication, and via long-distance wireless communication, such as GSM communication, 3G communication, WiMax communication, or LTE communication. In this case, the communication unit 170 preferably communicates with the vehicle terminal devices 200 and the delineator modules 400 via the short-distance wireless communication, and preferably communicates with the central control server 10 via the long-distance wireless communication. The communication unit 170 may transmit a lighting signal to the delineator modules 400, and may transmit and receive accident information, location information, a processing completion signal, and the like to and from the vehicle terminal devices 200. Furthermore, the communication unit 170 may transmit a weather information request signal to the central control server 10, and may receive weather information from the central control server 10.

Each of the accident management devices 100 may receive power from the outside, and may further include a battery, a solar panel, and a solar panel controller for an emergency. The solar panel controller is a module configured to stably control the power of the solar panel, and the solar panel is a device configured to convert solar light into electrical energy.

Each of the vehicle terminal devices 200 transmits accident information and location information to the accident management devices 100 when a vehicle abnormality detection signal or a risk signal attributable to user operation is generated. More specifically, referring to FIG. 2, the corresponding vehicle terminal device 200 includes a sensing unit 230, a control unit 250, and a terminal communication unit 260, and may further include a notification unit 270, a location extraction unit 280, and an emergency button 290.

The sensing unit 230 generates a vehicle abnormality detection signal through the detection of an impact generated when an accident occurs. The sensing unit 230 may include at least one of an impact sensor, a speed sensor, an acceleration sensor, a gyro sensor, a wheel sensor, and a vibration sensor, or may detect the occurrence of an accident through the reception of a signal from an impact detection sensor installed in a vehicle. For example, in the case in which the sensing unit 230 includes an impact sensor, the impact sensor may measure the strength of an impact on a scale of 0 to 16, may generate a vehicle abnormality detection signal when the strength of the impact is equal to or higher than a preset value, and may transmit the vehicle abnormality detection signal to the terminal control unit 250.

The terminal control unit 250 controls the corresponding vehicle terminal device 200, and generates accident information and location information when a vehicle abnormality detection signal is generated by the sensing unit 230 or a risk signal is generated by the emergency button 190. Furthermore, the terminal control unit 250 may receive outside temperature and humidity information from a vehicle, and may include the outside temperature and humidity information in the accident information. The outside temperature and humidity information included in the accident information is information indicative of whether it is raining or snowing in a corresponding region and whether fog or sea fog is present in the corresponding region. The effect of inducing a driver to drive safely is provided when the temperature and humidity information of a specific region is provided to the following vehicle entering the corresponding region.

The terminal communication unit 260 may communicate with the accident management devices 100 and the central control server 10, and may also communicate with the delineator modules 400 based on user settings. The terminal communication unit 260 of the corresponding vehicle terminal device 200 may rapidly transmit and receive information to and from the accident management devices 100 via short-distance wireless communication, and may transmit and receive various types of current road state information to and from the central control server 10 via long-distance wireless communication. The terminal communication unit 260 may transmit accident information, location information, and information about temperature and humidity outside a vehicle to the accident management devices 100 or central control server 10, and may receive accident information and location information regarding another vehicle from the accident management devices 100. Furthermore, the terminal communication unit 260 may receive weather information from the accident management devices 100 or central control server 10.

The terminal communication unit 260 may provide an alarm regarding the occurrence of an accident to the terminal means 300 connected to the corresponding vehicle terminal device 200 via wired or wireless communication. The terminal means 300 may be any one of a navigation device 300a, an audio device, and a black box attached to a vehicle, or may be the mobile phone 300b of a driver adjacent to the corresponding vehicle terminal device 200. For example, when an accident has occurred in front of a vehicle and accident information and location information have been received by the vehicle terminal device 200 of the following vehicle, the terminal communication unit 260 may receive the accident information and the location information, and may provide an alarm regarding the occurrence of the accident to the terminal means 300. In this case, a setting may be made such that accident occurrence alarm text or accident occurrence alarm graphics are displayed on the display of a navigation device or mobile phone, a warning sound is issued via an audio device, or the LED of a black box flickers. The terminal means 300 may provide an alarm regarding the occurrence of an accident to a user in a form suitable for the characteristics of the terminal means 300 based on preset environment settings when the alarm is received from the corresponding vehicle terminal device 200.

The notification unit 270 is responsible for the direct transfer of a signal, received from the accident management devices 100, to a driver. The notification unit 270 may provide accident information in the form of light or sound by using an LED lamp or a speaker module configured to notify a driver of a dangerous situation via sound.

The location extraction unit 280 may extract information about the location of the corresponding vehicle terminal device 200 to be transferred to the accident management devices 100, and may be implemented using a GPS module.

The emergency button 290 is operated based on user operation, may generate a risk signal attributable to user operation, and may be implemented in the form of a button or touch interface. The emergency button 290 may be a single button, or may include a button for the notification of the occurrence of an accident and a button for the transfer of simple information. For example, a driver may generate accident information by pushing the button for the notification of the occurrence of an accident when an accident, such as a collision accident, has occurred and a vehicle has stopped. Furthermore, a driver may provide temperature and humidity information or an alarm, adapted to induce a driver to drive safely, to the driver of the following vehicle by pushing the button for the transfer of simple information when the attention of the driver of the following vehicle is required due to an environmental factor, such as lack of sight attributable to fog covering the surface of a road or the like.

Each of the delineator modules 400 constantly or intermittently emits light when a lighting signal is received from one of the accident management devices 100. Whether to constantly or intermittently emit light is determined based on preset environment settings, and may be changed based on a lighting signal received from the accident management devices 100.

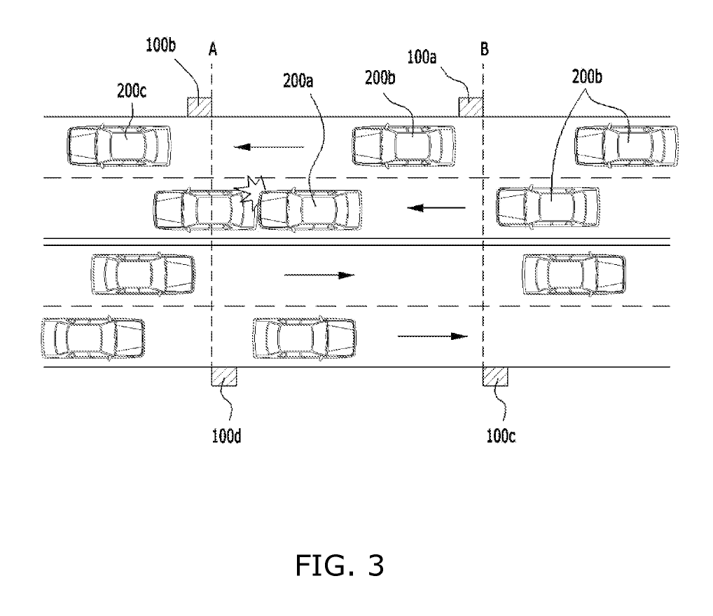

FIG. 3 is a diagram illustrating the exemplary operation of a vehicle accident management system according to an embodiment of the present invention. In the following description, vehicles, to which vehicle terminal devices 200a, 200b and 200c have been attached, will be designated as vehicles 200a, 200b and 200c, respectively, for convenience of description.

Referring to FIG. 3, the embodiment in which a section from A to B corresponds to a bridge frequently covered with fog and sea fog will be described. When an accident, in which a vehicle 200a traveling on the bridge has collided with a preceding car, has occurred, the vehicle 200a may detect an impact via an attached impact detection sensor or a sensor, included in the vehicle terminal device 200a, and may generate a vehicle abnormality detection signal. The vehicle 200a may transmit accident information and location information to neighboring accident management devices 100a, 100b, and 100d when the vehicle abnormality detection signal is generated. Each of the accident management devices 100 may previously set a management region disposed within a road, and may receive and process only a signal, generated within the management region managed by the corresponding accident management device. In other words, in this case, only the accident management device 100a may receive and process a signal transmitted by the vehicle 200a. Even when the accident management device 100b or 100d, not managing the region at which the accident has occurred, receives the accident information and the location information, the accident information and the location information are not transmitted to a vehicle not requiring the reception of the information because the accident management devices 100 search for the second vehicle terminal device 200b having a moving direction identical to that of the vehicle 200a and located within a preset distance behind the vehicle 200a. In the case in which the delineator modules 400 are installed in median strips or roadsides, the accident management device 100a may transmit a signal to the vehicle 200b and a delineator module disposed in the moving direction of the vehicle 200a and located within a preset distance behind the vehicle 200a until a processing completion signal is received from the vehicle 200a.

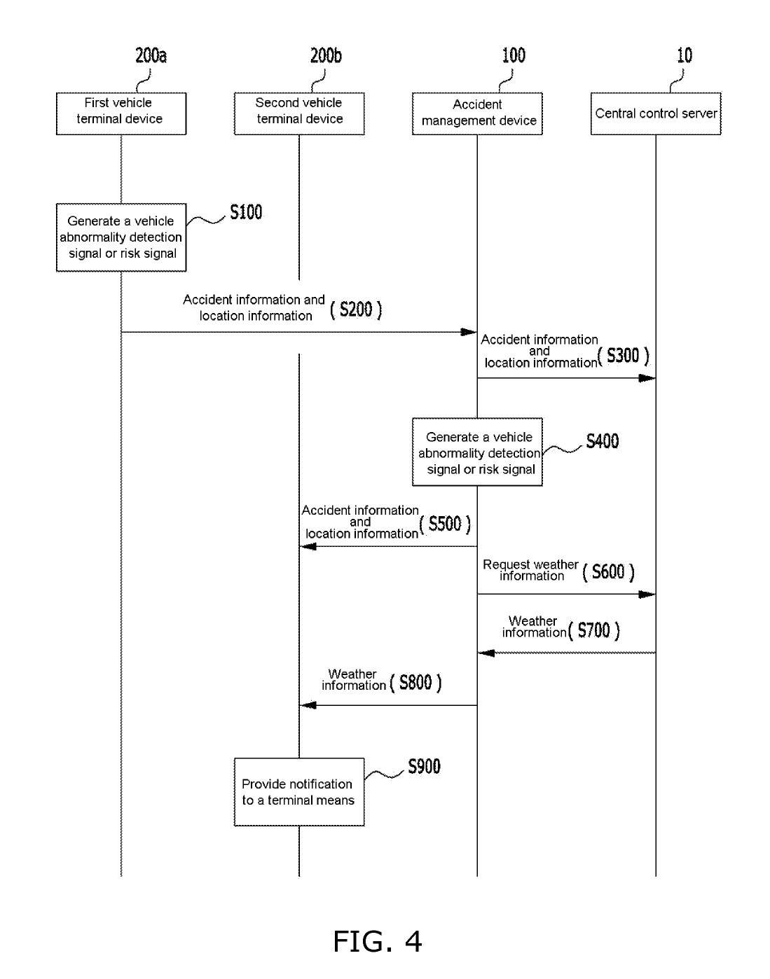

FIG. 4 is a flowchart illustrating a method for operating a vehicle accident management system according to an embodiment of the present invention.

Referring to FIG. 4, according to the method for operating a vehicle accident management system including vehicles to which respective vehicle terminal devices are attached, and an accident management device which is installed on a roadside, when a vehicle abnormality detection signal or a risk signal attributable to user operation is generated at step S100, a first vehicle terminal device transmits accident information and location information to the accident management device at step S200. In this case, outside temperature and humidity information provided by a vehicle may be included in the accident information. When the accident management device receives the accident information and the location information from the first vehicle terminal device at step S200, the accident management device may transfer the accident information and the location information to a central control server at step S300. At step S400, the accident management device searches for a second vehicle terminal device having a moving direction identical to that of the first vehicle terminal device and located within a preset distance behind the first vehicle terminal device. At step S500, the accident management device transmits the accident information and the location information to the second vehicle terminal device based on the result of the search. At step S600, the accident management device may request the weather information of a region corresponding to the location information from the central control server by using the location information after the urgent accident information and the urgent location information have been transferred to the second vehicle terminal device. When the weather information is received from the central control server at step S700, the accident management device transmits the weather information to the second vehicle terminal device at step S800, thereby enabling the following vehicle to check the weather information of an accident region. At step S900, the second vehicle terminal device having received the accident information and the location information with or without the weather information provides an alarm to a terminal means 300, thereby inducing the driver of the following vehicle to check the corresponding information. The above-described steps S400 to S900 may be repeatedly performed until a processing completion signal is received from the first vehicle terminal device.

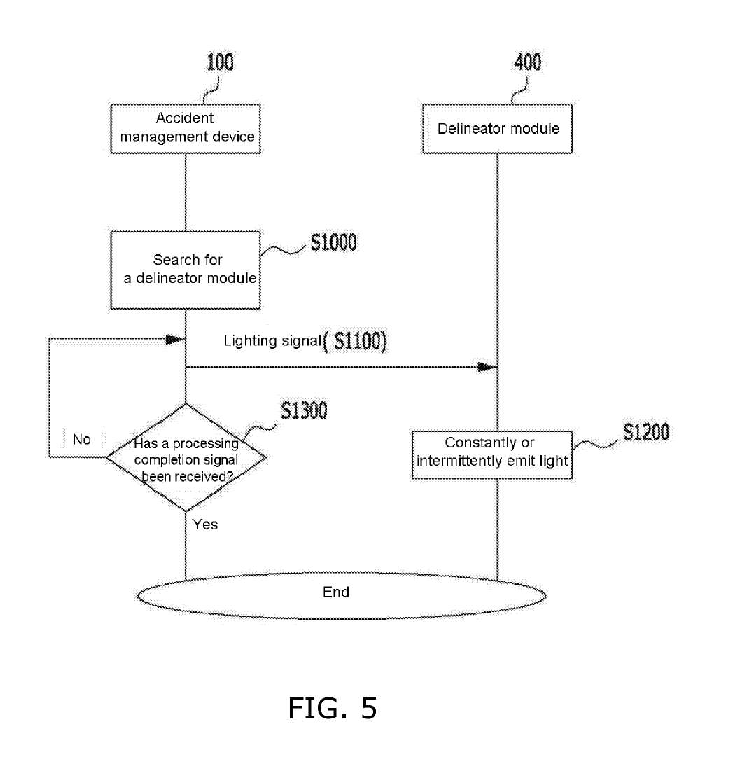

Referring to FIG. 5, the accident management device according to the present invention may search for a delineator module disposed in the moving direction of the first vehicle terminal device and located within a preset distance behind the first vehicle terminal device at step S1000. At step S1100, the accident management device transmits a lighting signal to the found delineator module. At step S1200, the delineator module having received the lighting signal may constantly or intermittently emit light. The accident management device and the delineator module may repeatedly perform steps S1000 to S1200 until a processing completion signal is received from the first vehicle terminal device.

According to the above-described present invention, neighboring vehicles are notified of a sudden change in a forward driving environment, and thus vehicles entering the corresponding driving environment under the influence of the sudden change are enabled to detect a dangerous situation, thereby preventing a secondary accident.

Furthermore, there can be provided a vehicle accident management system that enables information about an accident occurring within a predetermined range to be shared with neighboring vehicles in real time and also enables information, which a driver needs to be aware of, to be provided at required time, thereby making a vehicle flow smooth.

In the above-described present invention, various substitutions, modifications, and alterations may be made without departing from the spirit of the present invention by those skilled in the art, and thus the present invention is not limited to the above-described embodiments and the accompanying drawings.

Furthermore, it should be noted that the above-described detailed embodiments of the accident management system according to the present invention may be applied to the method for operating the accident management system in the same manner.

What is claimed is:

1. A method for operating a vehicle accident management system including vehicles configured such that respective vehicle terminal devices are attached thereto and an accident management device installed on a roadside, the method comprising:
transmitting, by a first vehicle terminal device, accident information and location information to the accident management device when a vehicle abnormality detection signal or a risk signal attributable to user operation is generated;
receiving, by the accident management device, the accident information and the location information from the first vehicle terminal device;
searching, by the accident management device, for a second vehicle terminal device having a moving direction identical to that of the first vehicle terminal device and located within a preset distance behind the first vehicle terminal device, and also searching, by the accident management device, for a delineator module disposed in the moving direction of the first vehicle terminal device and located within the preset distance behind the first vehicle terminal device;
based on a result of the search, transmitting, by the accident management device, the accident information and the location information to the second vehicle terminal device, and transmitting, by the accident management device, a lighting signal to the delineator module; and
constantly or intermittently emitting, by the delineator module, light when receiving the lighting signal.

2. The method of claim 1, wherein:
the accident information comprises outside temperature and humidity information provided by the corresponding vehicle; and
the accident management device transmits signals to the second vehicle terminal device having the moving direction identical to that of the first vehicle terminal device and located within the preset distance behind the first vehicle terminal device and the delineator module disposed in the moving direction of the first vehicle terminal device and located within the preset distance behind the first vehicle terminal device until an accident processing completion signal is received from the first vehicle terminal device.

3. The method of claim 1, further comprising:
requesting, by the accident management device, weather information of a region corresponding to the location information from a central control server;
receiving, by the accident management device, the weather information from the central control server; and
transmitting, by the accident management device, the weather information to the second vehicle terminal device.

4. The method of claim 1, further comprising:
receiving, by the second vehicle terminal device, the accident information and the location information from the accident management device; and
providing, by the second vehicle terminal device, an alarm regarding occurrence of an accident to a terminal means connected to the second vehicle terminal device via wired or wireless communication.

5. A vehicle accident management system, comprising:
a first vehicle terminal device configured to transmit accident information and location information to the accident management device when a vehicle abnormality detection signal or a risk signal attributable to user operation is generated;
a delineator module configured to constantly or intermittently emit light when a lighting signal is received from the accident management device; and
an accident management device attached to a vehicle, and configured to receive the accident information and the location information from the first vehicle terminal device, to search for a second vehicle terminal device, attached to another vehicle, having a moving direction identical to that of the first vehicle terminal device, and located within a preset distance behind the first vehicle terminal device and also search for the delineator module disposed in the moving direction of the first vehicle terminal device and located within the preset distance behind the first vehicle terminal device, to transmit the accident information and the location information to the second vehicle terminal device based on a result of the search, and to transmit the lighting signal to the delineator module based on the result of the search.

6. The vehicle accident management system of claim 5, wherein:
the first vehicle terminal device comprises:
a terminal communication unit configured to communicate with the accident management device;
a sensing unit configured to detect an impact generated when an accident occurs and to generate a vehicle abnormality detection signal;
an emergency button configured to generate a risk signal based on user operation; and
a control unit configured to receive outside temperature and humidity information from the corresponding vehicle;
the accident management device comprises:
a communication unit configured to communicate with the vehicle terminal device, the delineator module, and a central control server; and
a control unit configured to search for the second vehicle terminal device and the delineator module; and
the accident management device transmits signals to the second vehicle terminal device having the moving direction identical to that of the first vehicle terminal device and located within the preset distance behind the first vehicle terminal device and the delineator module disposed in the moving direction of the first vehicle terminal device and located within the preset distance behind the first vehicle terminal device until an accident processing completion signal is received from the first vehicle terminal device.

7. The vehicle accident management system of claim 5, wherein the accident management device comprises a communication unit configured to request weather information of a region corresponding to the location information from a central control server, to receive the weather information from the central control server, and to transmit the weather information to the second vehicle terminal device.

8. The vehicle accident management system of claim 5, wherein the second vehicle terminal device receives the accident information and the location information from the accident management device, and provides an alarm regarding occurrence of an accident to a terminal means connected via wired or wireless communication.
